(19) United States
(12) Patent Application Publication
(10) Pub. No.: US 2019/0331310 A1
(43) Pub. Date: Oct. 31, 2019

(54) METHOD FOR PRODUCING AN ATTACHMENT OPTICAL UNIT ARRAY FOR A VEHICLE HEADLAMP

(71) Applicant: DOCTER OPTICS SE, Neustadt an der Orla (DE)

(72) Inventors: Wolfram WINTZER, Jena (DE); Alex ZEVAKOV, Harth-Pöllnitz (DE); Jürgen HÄDRICH, Auma-Weidatal (DE); Peter RUHS, Rudolstadt (DE); Bernhard ARNDT, Schleiz (DE); Steffen DITTMAR, Würzbach (DE)

(21) Appl. No.: 16/310,465

(22) PCT Filed: Apr. 7, 2017
(86) PCT No.: PCT/EP2017/000444

§ 371 Date: Dec. 17, 2018

(30) Foreign Application Priority Data
Jun. 17, 2016 (DE) 10 2016 007 345.4
Jun. 23, 2016 (DE) 10 2016 007 640.2
Feb. 25, 2017 (DE) 10 2017 001 932.0
Mar. 14, 2017 (DE) 10 2017 002 394.8

(51) Int. Cl. F21S 41/20; F21S 43/31; C03B 11/08

(52) U.S. Cl. CPC F21S 41/285; F21S 43/315; C03B 2215/414; C03B 2215/412; C03B 11/082

(57) ABSTRACT

The invention relates to a method of manufacturing an primary optical array for a vehicle headlight, wherein the primary optical array comprises a first primary optical element with a light entry face, at least one second primary optical element with a light entry face, and a basic part connecting the first primary optical element mechanically to the second primary optical element, wherein a first mold and a second mold are provided, wherein the first mold comprises at least one first web for molding a side face of the first primary optical element facing the second primary optical element, and for molding a side face of the second primary optical element facing the first primary optical element, wherein the at least one first web has a web edge the width of which amounts to no more than 0.25 mm, wherein a gob is placed between the first mold and the second mold, wherein the gob is press-molded or pressed into the primary optical array by the first mold and the second mold moving towards each other.

### CROSS-REFERENCE TO RELATED APPLICATIONS

This application is a U.S. national counterpart application of international application serial No. PCT/EP2017/000444, filed Apr. 7, 2017, which claims priority to German Patent Application Nos. 102016007345.4, 102016007640.2, 102017001932.0 and 102017002394.8 filed Jun. 17, 2016, Jun. 23, 2016, Feb. 25, 2017, and Mar. 14, 2017 (respectively).

### FIELD OF THE INVENTION

The invention relates to a method of manufacturing an primary optical array for a vehicle headlight, for example a motor vehicle headlight, wherein the primary optical array comprises a first primary optical element with a light entry face and/or a light exit face, at least one second primary optical element with a light entry face and/or a light exit face, and a basic part connecting the first primary optical element mechanically to the second primary optical element. The invention moreover relates to an primary optical array of inorganic glass.

### BACKGROUND

DE 10 2013 013 456 A1 discloses an optical element for a vehicle headlight with a monolithically pressed first primary optical array of inorganic glass, and at least one second, monolithically pressed second primary optical array of inorganic glass, wherein the first primary optical array comprises a first primary optical element with a light entry face and a light exit face, at least one second primary optical element with a light entry face and a light exit face, and a web connecting the first primary optical element mechanically to the second primary optical element. The second primary optical array comprises a third primary optical element with a light entry face and a light exit face, a fourth primary optical element with a light entry face and a light exit face, and a web connecting the third primary optical element mechanically to the fourth primary optical element, wherein the first primary optical array and the second primary optical array engage each other such that they form an array.

DE 10 2013 021 795 A1 discloses an alternative method of manufacturing a headlight lens array to be used as an primary optical element in a vehicle headlight. Here, a transparent plastic body is three-dimensionally printed onto a glass substrate so that a three-dimensional structure having an optically effective first light exit face, and at least one second three-dimensional structure having an effective second light exit face, which is connected to the first light exit face by means of a notch, are generated.

The use of primary optical elements is moreover disclosed, for example, in DE 10 2010 029 176 A1 (referred to as primary optic there), EP 3 121 510 A1, DE 10 2011 085 315 A1, and DE 10 2013 200 442 B3.

### SUMMARY

An embodiment concerns a monolithic primary optical array, or an primary optical array monolithically pressed from inorganic glass, for a vehicle headlight, for example for a motor vehicle headlight, or by a monolithic primary optical array of inorganic glass for a vehicle headlight, for example for a motor vehicle headlight, wherein the primary optical array comprises
a first primary optical element with a(n) (optionally optically effective) light entry face and/or a(n) (optionally optically effective) light exit face,
at least one second primary optical element with a(n) (optionally optically effective) light entry face and/or a(n) (optionally optically effective) light exit face, and
a basic part connecting the first primary optical element mechanically to the second primary optical element,

wherein for example the distance between the first primary optical element and the second primary optical element amounts to no more than 0.5 mm, for example no more than 0.25 mm, for example no more than 0.15 mm, for example no more than 0.1 mm. Here, for example, the surface of the basic part facing away from the first primary optical element and the second primary optical element forms the light exit face.

An optically effective light entry face or an optically effective light exit face in the sense of the disclosure is for example an optically effective surface. An optically effective surface (with respect to the light entry face or the light exit face) in the sense of the disclosure is for example a surface where refraction of light occurs when the primary optical element is used according to its purpose. An optically effective surface (with respect to the light entry face or the light exit face) in the sense of the disclosure is for example a surface where the direction of light passing through this surface is changed when the primary optical element is used according to its purpose.

Inorganic glass in the sense of the disclosure is for example silicate glass. Inorganic glass in the sense of the disclosure is for example glass as it is described in PCT/EP2008/010136. Inorganic glass in the sense of the disclosure for example comprises:
0.2 to 2 weight percent of Al₂O₃,
0.1 to 1 weight percent of Li₂O,
0.3, for example 0.4 to 1.5 weight percent of Sb₂O₃,
60 to 75 weight percent of SiO₂,
3 to 12 weight percent of Na₂O,
3 to 12 weight percent of K₂O, and
3 to 12 weight percent of CaO.

An primary optical element in the sense of the disclosure may be a light tunnel or a light conductor. An primary optical element in the sense of the disclosure for example serves the orientation of light (by means of TIR) being irradiated into the light entry face, wherein for example (correspondingly) directed light exits through the light exit face or from the primary optical array. An primary optical array in the sense of the disclosure is for example suited to create an illumination pattern which can be imaged or is imaged by means of a secondary optical system as bright-dark boundary. An primary optical array in the sense of the disclosure is for example a primary optic for a matrix headlight.

The distance between two primary optical elements in the sense of the disclosure is for example the smallest distance or the minimum distance between the two primary optical elements. The distance of two primary optical elements in the sense of the disclosure is for example the distance or the smallest distance, or the sharp measure of the smallest distance between the transition of an primary optical element into the basic part and the transition of an adjacent primary optical element into the basic part. For example, the distance between the first primary optical element and the second primary optical element is for example the smallest distance or the sharp measure of the smallest distance between the transition of the first primary optical element into the basic part and the transition of the second primary optical element into the basic part.

In an embodiment of the invention, the first primary optical element transitions into the basic part such that light irradiated into the light entry face of the first primary optical element (essentially) exits from the basic part or a surface of the basic part facing away from the primary optical element. In a further embodiment of the invention, the second primary optical element transitions into the basic part such that light irradiated into the light entry face of the second primary optical element (essentially) exits from the basic part or a surface of the basic part facing away from the primary optical element. For example, the distance between the first primary optical element and the second primary optical element is no larger than 20%, for example no larger than 10%, of the length of the (shortest) light path from the light entry face of the first primary optical element to the exit as intended from the primary optical array (for example from the basic part or from a light exit face of the first primary optical element), and/or the length of the (shortest) light path from the light entry face of the second primary optical element to the exit as intended from the primary optical array (for example from the basic part or from a light exit face of the second primary optical element).

In a further embodiment of the invention, the primary optical array comprises a third primary optical element with a(n) (optionally optically effective) light entry face and/or a(n) (optionally optically effective) light exit face, wherein the third primary optical element is connected to the second primary optical element by means of the basic part, and wherein the distance between the third primary optical element and the second primary optical element amounts to no more than 0.25 mm, for example no more than 0.15 mm, for example no more than 0.1 mm. In a further embodiment of the invention, the third primary optical element transitions into the basic part such that light irradiated into the light entry face of the third primary optical element (essentially) exits from the basic part or a surface of the basic part facing away from the primary optical element. For example, the distance between the first primary optical element and the second primary optical element is no larger than 20%, for example no larger than 10%, of the length of the (shortest) light path from the light entry face of the second primary optical element to the exit as intended from the primary optical array (for example from the basic part or from a light exit face of the second primary optical element), and/or the length of the (shortest) light path from the light entry face of the third primary optical element to the exit as intended from the primary optical array (for example from the basic part or from a light exit face of the third primary optical element).

In a further embodiment of the invention, the primary optical array comprises a fourth primary optical element with a(n) (optionally optically effective) light entry face and/or a(n) (optionally optically effective) light exit face, wherein the fourth primary optical element is connected to the third primary optical element by means of the basic part, and wherein the distance between the fourth primary optical element and the third primary optical element amounts to no more than 0.25 mm, for example no more than 0.15 mm, for example no more than 0.1 mm. In a further embodiment of the invention, the fourth primary optical element transitions into the basic part such that light irradiated into the light entry face of the fourth primary optical element (essentially) exits from the basic part or a surface of the basic part facing away from the primary optical element. For example, the distance between the first primary optical element and the second primary optical element is no larger than 20%, for example no larger than 10%, of the length of the (shortest) light path from the light entry face of the third primary optical element to the exit as intended from the primary optical array (for example from the basic part or from a light exit face of the third primary optical element), and/or the length of the (shortest) light path from the light entry face of the fourth primary optical element to the exit as intended from the primary optical array (for example from the basic part or from a light exit face of the fourth primary optical element).

In a further embodiment of the invention, the primary optical array comprises a fifth primary optical element with a(n) (optionally optically effective) light entry face and/or a(n) (optionally optically effective) light exit face, wherein the fifth primary optical element is connected to the fourth primary optical element by means of the basic part, and wherein the distance between the fifth primary optical element and the fourth primary optical element amounts to no more than 0.25 mm, for example no more than 0.15 mm, for example no more than 0.1 mm. In a further embodiment of the invention, the fifth primary optical element transitions into the basic part such that light irradiated into the light entry face of the fifth primary optical element (essentially) exits from the basic part or a surface of the basic part facing away from the primary optical element. For example, the distance between the first primary optical element and the second primary optical element is no larger than 20%, for example no larger than 10%, of the length of the (shortest) light path from the light entry face of the fourth primary optical element to the exit as intended from the primary optical array (for example from the basic part or from a light exit face of the fourth primary optical element), and/or the length of the (shortest) light path from the light entry face of the fifth primary optical element to the exit as intended from the primary optical array (for example from the basic part or from a light exit face of the fifth primary optical element).

In a further embodiment of the invention, an primary optical element or the first primary optical element, the second primary optical element, the third primary optical element, the fourth primary optical element, and/or the fifth primary optical element comprises, between their light entry face and the basic part (or its light exit face), a(n) (for example press-molded) surface, for example for the total reflection (TIR) of light irradiated into the light entry face.

The optical axes of individual primary optical elements may be inclined or tilted, for example by a few degrees, with respect to the optical axes of other primary optical elements.

The distances between the primary optical elements of an primary optical array may vary, i. e. may not be equidistant. The primary optical elements of an primary optical array may have different widths.

The light entry faces and/or the light exit faces of the primary optical elements or one of the primary optical elements may be polished.

In a further preferred embodiment of the invention, the light exit face of at least one primary optical element or an for example polished surface of the basic part facing away from the first, the second, the third, the fourth and/or the fifth primary optical element, a region of a first roughness and a region of a second roughness, wherein the region of the first roughness has a roughness for example at least three times the roughness of the region of the second roughness. In a further embodiment of the invention, the roughness Ra of the region of the first roughness is between 0.3 μm and 2 μm, for example between 0.5 μm and 1 μm. In a further embodiment of the invention, the roughness Ra of the region of the second roughness is no greater than 0.1 μm, for example no greater than 0.05 μm. For example, the region of the second roughness of the surface is a coating. For example, the coating is curved, for example in a convex manner. The coating may comprise a varnish or an adhesive. The coating may be applied by stamp printing, or for example by 3D printing processes. In an embodiment of the invention, the coating comprises Ormocer and/or consists of Ormocer. In one embodiment of the invention, an optical axis (used as a synonym for main axis) of an primary optical element extends through a region of second roughness. In an embodiment of the invention, the basic part comprises, at its circumference, a bend or a double-bend for creating a corresponding bend or double-bend in the bright-dark boundary, wherein the coating is advantageously provided in the region of the bend or the double-bend.

For example, the distance of two adjacent primary optical elements in an array (not in an primary optical array) is not smaller than 50 μm.

In a further embodiment of the invention, a vehicle headlight, for example a motor vehicle headlight, comprises an aforementioned primary optical array and a light source arrangement, for example comprising an LED, for coupling light into the light entry face(s). In a further embodiment of the invention, the light source arrangement comprises at least one LED or an arrangement of LEDs. In an embodiment of the invention, the light source arrangement comprises at least one OLED or an arrangement of OLEDs. The light source arrangement may also be, for example, an extended illuminated field. For example, the vehicle headlight comprises a secondary lens for imaging the light exit from the primary optical array or for imaging the plane from which light exits from the primary optical element as a bright-dark boundary.

Another embodiment concerns a method of manufacturing an primary optical array for a vehicle headlight, for example a motor vehicle headlight, wherein the primary optical array comprises a first primary optical element with a(n) (optionally optically effective) light entry face and/or a(n) (optionally optically effective) light exit face, at least one second primary optical element with a(n) (optionally optically effective) light entry face and/or a(n) (optionally optically effective) light exit face, and a basic part connecting the first primary optical element (mechanically) to the second primary optical element, for example for manufacturing an primary optical array having one or several ones of the aforementioned features, wherein a first mold and a second mold are provided, wherein the first mold comprises at least one first web for molding a side face of the first primary optical element facing the second primary optical element, and for molding a side face of the second primary optical element facing the first primary optical element, wherein advantageously the at least one first web has a web edge of which the (minimum) width (i. e. the width at its thinnest point) amounts to no more than 0.5 mm, for example no more than 0.25 mm, for example no more than 0.15 mm, for example no more than 0.1 mm, wherein a (heated) gob is placed between the first and the second molds, wherein the gob is press-molded or pressed into the primary optical array or into an primary optical array blank by the first mold and the second mold moving towards each other, wherein advantageously the temperature of the gob inside the gob directly prior to pressing is lower by at least 100 K, for example at least 150 K, than the temperature of the gob (for example at the top) in the outer region or at the (for example upper) edge of the gob, and wherein for example the first mold and the second mold are moved towards each other during pressing or at least in a section of pressing, for example during the penetration of the (first) mold into the gob, at a speed of no less than 80 mm per second, advantageously no less than 100 mm per second, for example no less than 150 mm per second, for example no less than 200 mm per second.

Moving the first mold and the second mold towards each other can mean, in the sense of the invention, that the first mold is moved towards the second mold, the second mold is moved towards the first mold, or both the first mold and the second mold are moved. An aforementioned speed is for example an actual speed. The aforementioned section is no less than 10%, for example no less than 20% of the pressing path. The aforementioned section is no more than 40%, for example no more than 30% of the pressing path.

In a further embodiment of the invention, the first mold is a top mold. The first mold or the top mold may be embodied at least in two parts. For example, the first mold or the top mold may comprise a plunger and a sleeve enclosing the plunger. In a further embodiment of the invention, the second mold is a bottom mold and/or a pressing bottom. The second mold or the bottom mold may be embodied at least in two parts. For example, the second mold or the bottom mold may comprise a plunger and a sleeve enclosing the plunger.

In a further embodiment of the invention, a batch of 5000 primary optical arrays (good units) or primary optical array blanks (good units) are pressed or manufactured by no more than 5500 times repeating the aforementioned process by means of the same first mold and/or the same second mold.

The surface of the basic part facing away from the primary optical elements may be polished, for example in such a fashion that the primary optical array is obtained. If a pressing edge or an overpress is present, it is for example removed by polishing the surface of the basic part facing away from the primary optical elements. For example, a coating is partially applied to parts of the side of the basic part facing away from the primary optical elements or the light exit faces of the primary optical elements. This coating is for example applied by means of a 3D printing process.

Another embodiment concerns a method of manufacturing primary optical arrays for a vehicle headlight, for example a motor vehicle headlight,
wherein an at least double primary array blank (the word “at least” refers to the word “double”) is pressed, having a first primary optical element with a(n) (optionally optically effective) light entry face and/or a(n) (optionally optically effective) light exit face, a second primary optical element with a(n) (optionally optically effective) light entry face and/or a(n) (optionally optically effective) light exit face, a third primary optical element with a(n) (optionally optically effective) light entry face and/or a(n) (optionally optically effective) light exit face, at least one fourth primary optical element with a(n) (optionally optically effective) light entry face and/or a(n) (optionally optically effective) light exit face, and a basic part which connects (mechanically) the first primary optical element, the second primary optical element, the third primary optical element and the fourth primary optical element in such a fashion that the basic part comprises a notch on the one side of which the first primary optical element and the second primary optical element are arranged, and on the other side of which the third primary optical element and the fourth primary optical element are arranged,
wherein a first mold and a second mold are provided,
wherein the first mold comprises at least one first web for molding a side face of the first primary optical element facing the second primary optical element, and for molding a side face of the second primary optical element facing the first primary optical element, and at least one second web for molding a side face of the fourth primary optical element facing the third primary optical element, and for molding a side face of the third primary optical element facing the fourth primary optical element, and a third web for molding the notch,
wherein advantageously the first web has a web edge of which the (minimum) width amounts to no more than 0.5 mm, for example no more than 0.25 mm, for example no more than 0.15 mm, for example no more than 0.1 mm,
wherein advantageously the second web has a web edge of which the (minimum) width amounts to no more than 0.5 mm, for example no more than 0.25 mm, for example no more than 0.15 mm, for example no more than 0.1 mm,
wherein a (heated) gob is placed between the first mold and the second mold,
wherein the gob is press-molded or pressed into the double primary array blank by the first mold and the second mold moving towards each other,
wherein for example the temperature of the gob inside the gob directly prior to pressing or during pressing is lower by at least 100 K, for example at least 150 K, than the temperature of the gob (for example at the top) in the outer region or at the (for example upper) edge of the gob,
and wherein for example the first mold and the second mold are moved towards each other during pressing, or at least in a section of pressing, for example during the penetration of the (first) mold into the gob, at a speed of no less than 80 mm per second, advantageously no less than 100 mm per second, for example no less than 150 mm per second, for example no less than 200 mm per second.

Moving the first mold and the second mold towards each other can mean, in the sense of the invention, that the first mold is moved towards the second mold, the second mold is moved towards the first mold, or both the first mold and the second mold are moved. An aforementioned speed is for example an actual speed. The aforementioned section amounts to no less than 10%, for example no less than 20% of the pressing path. The aforementioned section amounts to no more than 40%, for example no more than 30% of the pressing path.

In a further embodiment of the invention, the first mold is a top mold. The first mold or the top mold may be embodied at least in two parts. For example, the first mold or the top mold may comprise a plunger and a sleeve enclosing the plunger. In a further embodiment of the invention, the second mold is a bottom mold and/or a pressing bottom. The second mold or the bottom mold may be embodied at least in two parts. For example, the second mold or the bottom mold may comprise a plunger and a sleeve enclosing the plunger.

In a further embodiment of the invention, a batch of 5000 double primary optical array blanks (good units) are pressed or manufactured by no more than 5500 times repeating the aforementioned method by means of the same first mold and/or the same second mold.

In a further embodiment of the invention, a surface of the basic part of the double primary optical array blank which is facing away from the first primary optical element, the second primary optical element, the third primary optical element, and the fourth primary optical element, is polished at least down to the notch, so that the double primary optical array blank splits at least into a first primary optical array, for example comprising one or several ones of the aforementioned features, and a second primary optical array, for example comprising one or several ones of the aforementioned features, wherein the first primary optical array comprises the first primary optical element and the second primary optical element, and a part of the basic part, and wherein the second primary optical array comprises the third primary optical element and the fourth primary optical element and a further part of the basic part. For example, by polishing the surface of the basic part of the double primary optical array blank facing away from the first primary optical element, the second primary optical element, the third primary optical element, and the fourth primary optical element, a potential overpress or pressing edge is removed (from the first primary optical array or the second primary optical array).

For example, a coating is partially applied onto parts of the side of the basic part facing away from the primary optical elements or the light exit faces of the primary optical elements. This coating is for example applied by means of a 3D printing process.

A gob in the sense of the invention is for example a glass blank or for example a glass blank in the form of a puck. A gob in the sense of the invention, however, may also comprise an elliptic base, or an angular, for example square or rectangular base. A gob in the sense of the invention is for example a pre-portioned glass part.

Press-molding in the sense of the invention for example means to press a(n) (for example optically effective) surface in such a way that a subsequent finishing of the contour of this (for example optically effective) surface may be omitted or is omitted or not intended at all. It is thus for example intended that a press-molded surface is not polished after press-molding.

Instead of Ormocer, another suited hybrid polymer can also be used.

An for example curved (for example convexly curved) coating may also be applied by means of a hollow needle. This procedure is particularly suited for applying a convexly curved coating having a geometric dimension in the millimetre range, or of several millimetres. For example, the curved coatings may be designed in the form of PDMS (polydimethylsiloxane) lenses having lens diameters and heights in a range of only a few millimetres. To this end, for example, a PDMS solution is measured out from a hollow needle onto a preheated region of the basic part to the polished surface of the basic part. Details can be found, for example, in the article Y. Sung et al., Journal of Biomedical Optics 20 (2015) (incorporated by reference in its entirety). The basic part or the polished surface of the basic part, or the part of the polished surface of the basic part to be coated is (therefore) advantageously preheated or heated prior to coating.

A motor vehicle in the sense of the invention is for example a land craft to be individually used in road traffic. Motor vehicles in the sense of the invention are for example not restricted to land crafts with an internal combustion engine.

### BRIEF DESCRIPTION OF THE FIGURES

FIG. 1 shows an exemplified embodiment of an primary optical array in a side view;

FIG. 2 shows the primary optical array of FIG. 1 in a plan view;

FIG. 3 shows a representation of section A-A according to FIG. 1;

FIG. 4 shows a schematic diagram of a mold for press-molding an primary optical array according to FIG. 1 or for press-molding an primary optical array blank from which an primary optical array according to FIG. 1 is obtained, for example by polishing;

FIG. 5 shows the mold according to FIG. 4 in a closed state;

FIG. 6 shows the mold according to FIG. 5 in a parted state after pressing;

FIG. 7 shows the transfer of the pressed primary optical array or for press-molding an primary optical array blank from which an primary optical array according to FIG. 1 is obtained, for example by polishing, to a gripper;

FIG. 8 shows a schematic diagram of an alternative form for press-molding an primary optical array according to FIG. 1 or for press-molding an primary optical array blank from which an primary optical array according to FIG. 1 is obtained, for example by polishing, in a closed state;

FIG. 9 shows an exemplified embodiment of a double primary optical array blank in a plan view;

FIG. 10 shows an exemplified embodiment of a mold set for pressing a double primary optical array blank according to FIG. 9;

FIG. 11 shows the mold set according to FIG. 10 in a cross-section represented orthogonally with respect to the cross-section according to FIG. 10;

FIG. 12 shows the double primary optical array blank according to FIG. 9 in a side view;

FIG. 13 shows an primary optical array polished out of the double primary optical array blank according to FIG. 9 or FIG. 12, respectively;

FIG. 14 shows an exemplified embodiment of an primary optical array with a coated light exit face;

FIG. 15 shows an enlarged sectional representation of the primary optical array according to FIG. 14;

FIG. 16 shows a further exemplified embodiment of an primary optical array with a coated light exit face;

FIG. 17 shows a sectional enlarged representation of the primary optical array according to FIG. 16;

FIG. 18 shows a further exemplified embodiment of an primary optical array with a coated light exit face;

FIG. 19 shows a further exemplified embodiment of an primary optical array with a coated light exit face; and

FIG. 20 shows a vehicle headlight or motor vehicle headlight using an primary optical array in a schematic representation.

### DETAILED DESCRIPTION

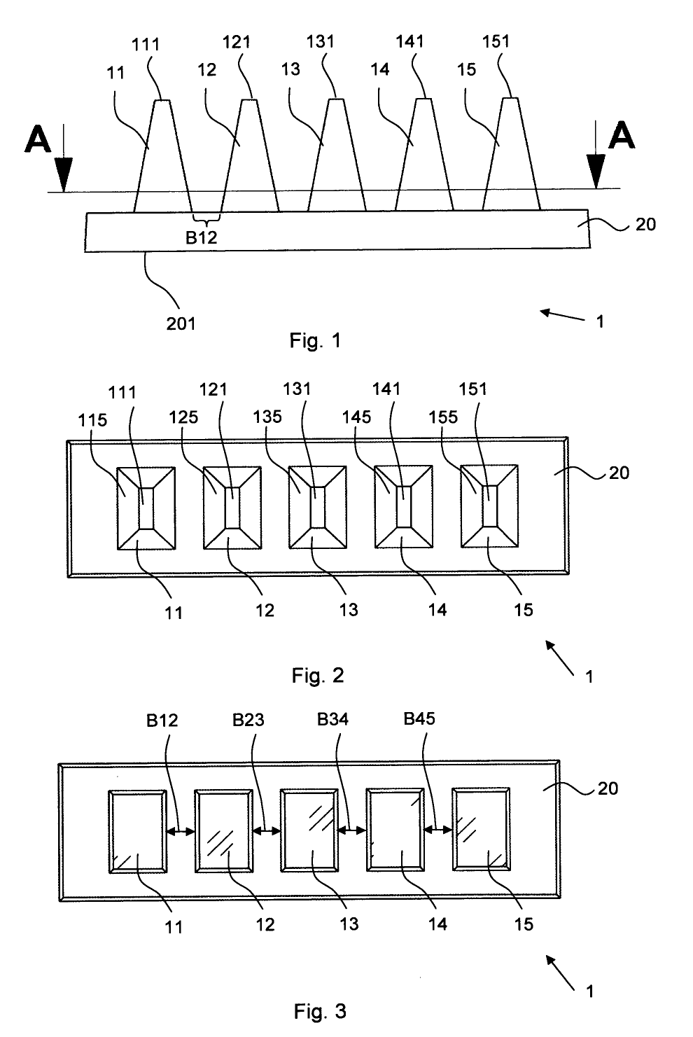

FIG. 1 shows an primary optical array 1 in a side view. FIG. 2 shows the primary optical array 1 in a plan view, and FIG. 3 shows the primary optical array in a plan view onto section A-A. The primary optical array 1 comprises a basic part 20 on which an primary optical element 11 with a light entry face 111, an primary optical element 12 with a light entry face 121, an primary optical element 13 with a light entry face 131, an primary optical element 14 with a light entry face 141, and an primary optical element 15 with a light entry face 151 are arranged. The side faces 115, 125, 135, 145, 155 of the primary optical elements 11, 12, 13, 14, 15 are press-molded and designed such that light entering into the respective light entry faces 111, 121, 131, 141 and 151, respectively, by means of a light source undergoes total reflection (TIR), so that said light exits from the basic part 20 or the surface 201 of the basic part 20 forming the common light exit face of the primary optical elements 11, 12, 13, 14 and 15. The distance B12 between the primary optical element 11 and the primary optical element 12 amounts to no more than 0.2 mm. In the represented embodiment, the distances B12, B23, B34, and B45 amount to 0.2 mm. The rounding radii between the light entry faces 111, 121, 131, 141, and 151 at the transition to the side faces 115, 125, 135, 145, and 155 amount to 0.16 to 0.2 mm.

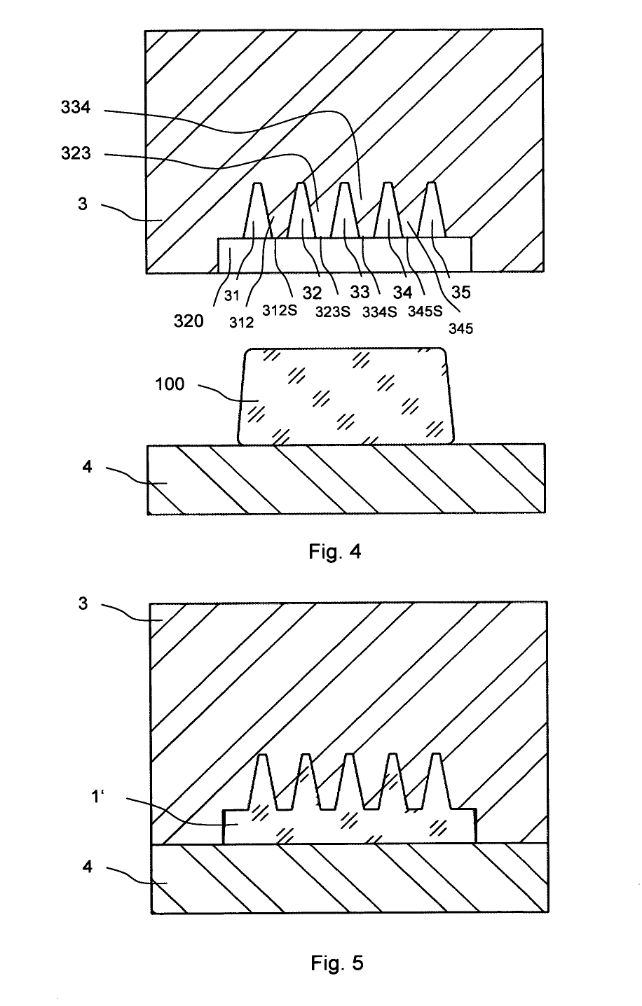

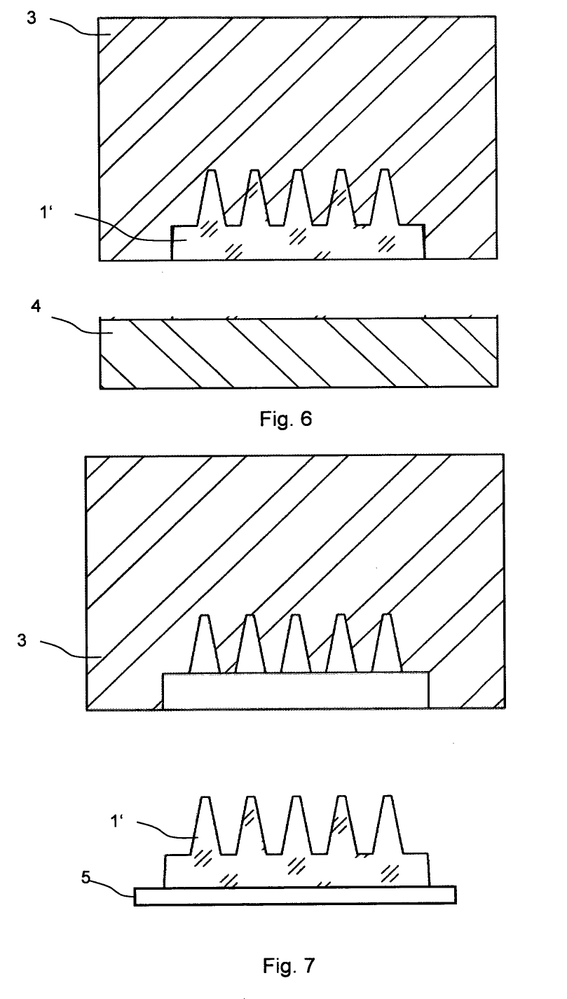

FIG. 4, FIG. 5, FIG. 6 and FIG. 7 show a method of manufacturing the primary optical element 1. To this end, a heated gob 100 is placed onto a pressing bottom 4. The gob 100 consists of glass having the following composition:
0.2 to 2 weight percent of Al₂O₃,
0.1 to 1 weight percent of Li₂O,
0.3, for example 0.4 to 1.5 weight percent of Sb₂O₃,
60 to 75 weight percent of SiO₂,
3 to 12 weight percent of Na₂O,
3 to 12 weight percent of K₂O, and
3 to 12 weight percent of CaO.

The gob is heated from a low temperature (not suited for pressing, e. g. room temperature) to a temperature amounting to, at the lower outer edge of the gob, approx. 630° C. to 675° C., for example 630° C. to 650° C., and at the upper edge to approx. 830° C. to 860° C. Moreover, a top mold 3 represented in a simplified manner (a cavity for receiving excessive material (overpress) is not represented) is provided and includes a cavity 320 for molding the basic part 20, a cavity 31 for molding the primary optical element 11, a cavity 32 for molding the primary optical element 12, a cavity 33 for molding the primary optical element 13, a cavity 34 for molding the primary optical element 14, and a cavity 35 for molding the primary optical element 15. The cavities 31 and 32 are separated by a web 312. The cavities 32 and 33 are separated by a web 323. The cavities 33 and 34 are separated by a web 334. The cavities 34 and 35 are separated by a web 345. The web edges 312S, 323S, 334S, and 345S of the webs 312, 323, 334, 345 have a (minimum) width essentially corresponding to the distances B12, B23, B34, and B45. The top mold 3 and the pressing bottom 4 are moved towards each other, wherein at least 10% of the pressing path (below referred to as high-speed region), where the top mold 3 contacts the gob 100 until the mold 3 or the pressing bottom 4 stands still, or until the position of the top mold 3 and the pressing bottom 4 represented in FIG. 5 is reached, the top mold 3 and the pressing bottom 4 are moved towards each other at a speed of at least 100 mm/s. The high-speed region comprises the portion of the pressing path in which the top mold 3 contacts the gob 100 or in which the top mold 3 contacts the upper surface of the gob, and/or penetrates the upper outer region of the gob 100.

The top mold 3 and the pressing bottom 4 are moved towards each other until they form a closed mold as shown in FIG. 5. Subsequently, the pressing bottom 4 and the top mold 3 are moved apart as is shown in FIG. 6. Then, a finished, pressed (primary optical array or) primary optical array blank 1′ is removed from the top mold 3 by means of an air surge and—as shown in FIG. 7—placed onto a cooling path for purposeful cooling by means of a gripper 5. The primary array blank 1′ may comprise a pressing edge or overpress which, however, is not represented in the simplified schematic diagram according to FIG. 7.

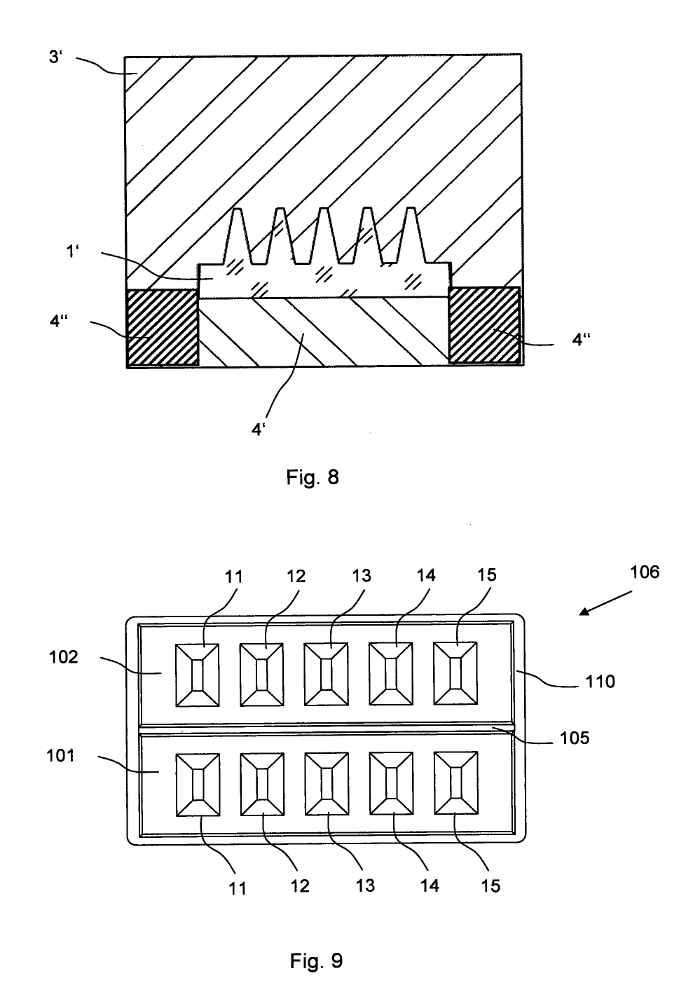

FIG. 8 shows the general representation of an alternative mold set for pressing the primary optical array 1. The alternative mold set comprises a top mold 3′ and a two-piece bottom mold having a plunger 4′ and a sleeve 4″ surrounding the plunger 4′.

For example, the primary optical array blank 1′ is subsequently polished on the side of the basic part 20 facing away from the primary optical elements 11, 12, 13, 14, and 15, that means at the bottom side, so that the polished surface 201 is formed according to the representation according to FIG. 1.

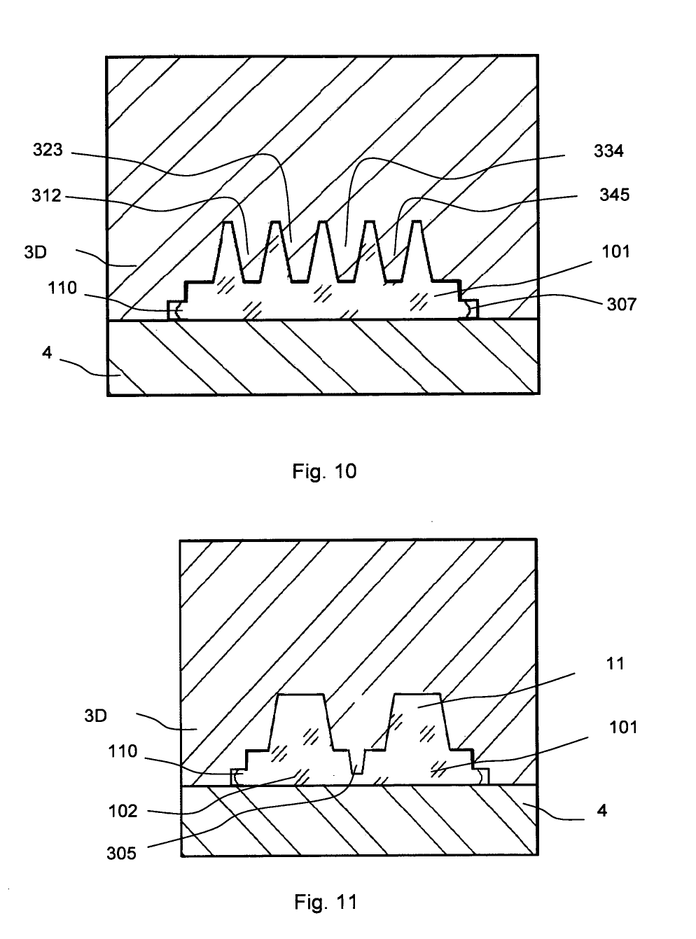

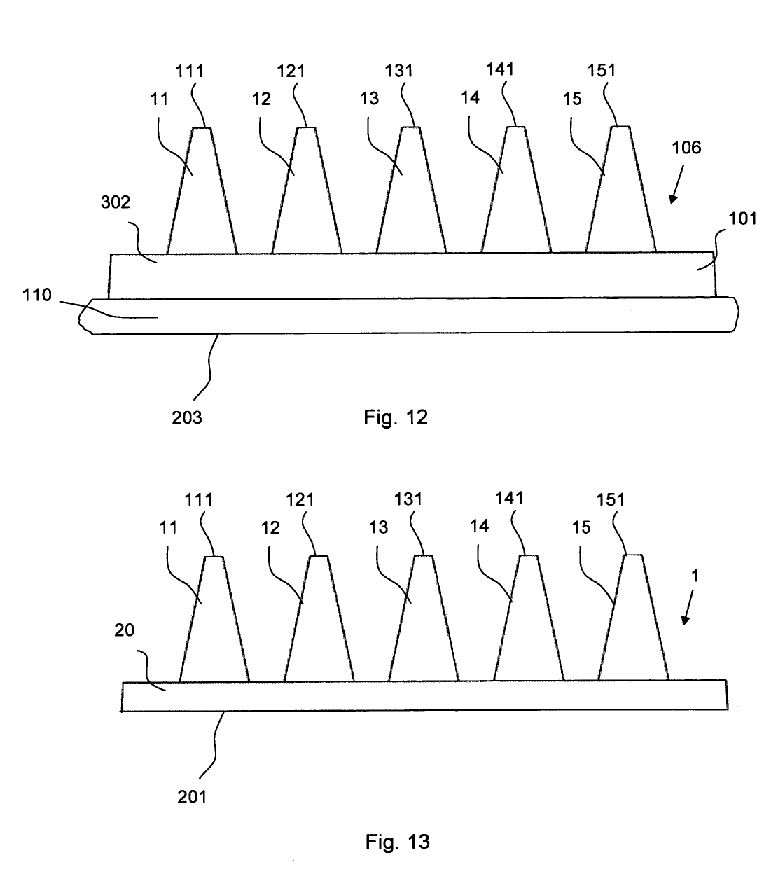

According to an embodiment, two primary optical arrays may be pressed from one gob, such as the gob 100. To this end, by means of the aforementioned molds, instead of an primary optical array blank, a double primary optical array blank 106 is pressed, as it is shown, for example, in FIG. 9 in a plan view and in FIG. 12 in a side view. The double primary optical array blank 106 according to FIG. 9 or FIG. 12, respectively, has a partial primary optical array blank 101 and a further partial primary optical array blank 102 which are connected via the bottom of a notch 105 between the partial primary optical array blank 101 and the partial primary optical array blank 102. Both the partial primary optical array blank 101 and the partial primary optical array blank 102 comprise primary optical elements 11, 12, 13, 14, and 15 on a common basic part 202. The double primary optical array blank 106 moreover optionally has an for example circumferential pressing edge 110 (overpress). This pressing edge 110 includes excessive glass. Here, the pressing edge 110 is arranged for example at the side edge of the basic part 20 in the region of the side of the double primary optical array blank 106 facing away from the primary optical elements 11, 12, 13, 14, and 15.

FIG. 10 and FIG. 11 show the pressing of the double primary optical array blank 106 and a mold set for pressing the double primary optical array blank 106, respectively. Here, FIG. 10 shows the mold set in a longitudinal cross-section, and FIG. 11 shows the mold set in a transverse cross-section. The mold set comprises a top mold 3d and a pressing bottom 4. The top mold 3d comprises two times the webs 312, 323, 334, and 345 each. Moreover, a cavity 307 is provided for receiving the pressing edge 110. Moreover, a longitudinally extending web 305 is provided by means of which the notch 105 is pressed.

By polishing the surface 203 of the double primary optical array blank facing away from the primary optical elements 11, 12, 13, 14, and 15 after pressing or cooling following the pressing, respectively, both the pressing edge 110 and the bottom of the notch 105 are removed. Thereby, the double primary optical array blank 106 is split into two primary optical arrays each corresponding to the primary optical array 1 represented in FIG. 1 and FIG. 13, respectively.

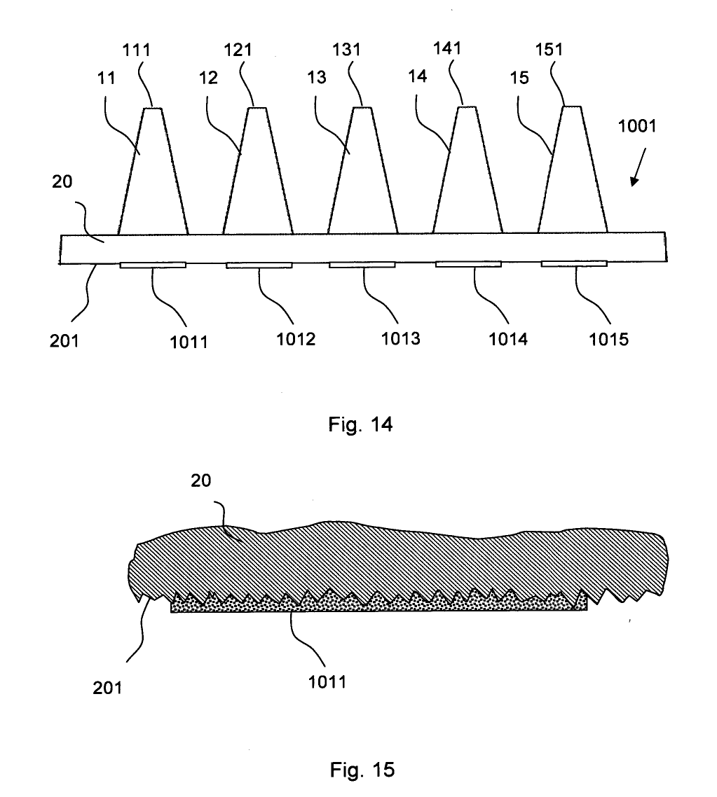

FIG. 14 shows a further exemplified embodiment of an primary optical array 1001 comprising the primary optical array 1, however supplemented by coatings 1011, 1012, 1013, 1014, and 1015. The surfaces of these coatings 1011, 1012, 1013, 1014, and 1015 have a lower roughness than the polished surface 201 of the basic part 20. By the coatings 1011, 1012, 1013, 1014, and 1015, the primary optical array 1001 has a light exit face comprising regions of different roughness. Here, the roughness of the light exit face, as shown in FIG. 15 in an enlarged view in a general representation, is higher between the primary optical elements 11, 12, 13, 14, and 15 than in the central region of the primary optical elements 11, 12, 13, 14, and 15.

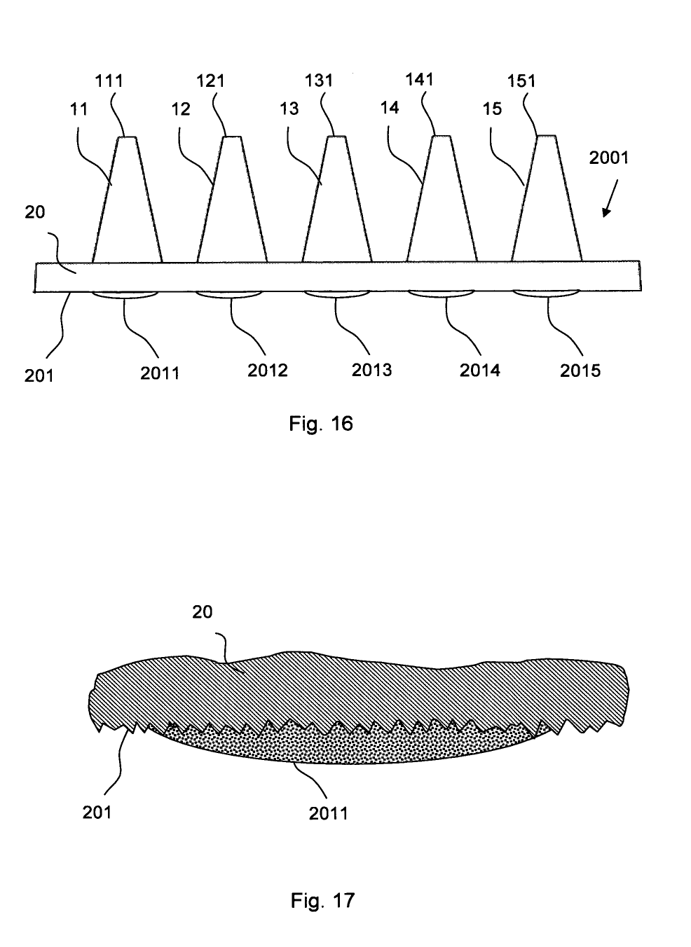

FIG. 16 shows a modified primary optical array 2001, wherein instead of the coatings 1011, 1012, 1013, 1014, and 1015, convex coatings 2011, 2012, 2013, 2014, and 2015 are provided. FIG. 17 shows such a convex coating 2011 in an enlarged general representation. Just as the coatings 1011, 1012, 1013, 1014, and 1015, the coatings 2011, 2012, 2013, 2014, and 2015 also have a surface having a lower roughness than the roughness of the polished surface 201 of the basic part 20. The coatings 1011, 1012, 1013, 1014, 1015, 2011, 2012, 2013, 2014, 2015 advantageously consist of Ormocer and are for example applied onto the polished surface 202 by a 3D printing process. Details concerning 3D printing processes (in a monolayer process) may be found e. g. in U.S. Pat. No. 5,498,444 (incorporated by reference in its entirety), the article W. Royall Cox, Ting Chen, Donald J. Hayes, Michael E. Grove: “Low-cost fiber collimation for MOEMS switches by ink-jet printing”, MOEMS and Miniaturized Systems II, M. Edward Motamedi, Rolf Goring, Editors, Proceedings of SPIE Vol. 4561 (2001), p. 93-101 (incorporated by reference in its entirety), and the book Inkjet-based Micromanufacturing, ISBN 978-3-527-31904-6 (incorporated by reference in its entirety). Details concerning 3D printing processes (in a monolayer process) may be found e. g. in DE 20 2009 017 825 U1, EP 2 396 682 B1, EP 2 631 686 B1, WO 2013/167685 A1, WO 2013/167528 A1, WO 2013/167415 A1, WO 2015/092014 A1 (each incorporated by reference in its entirety).

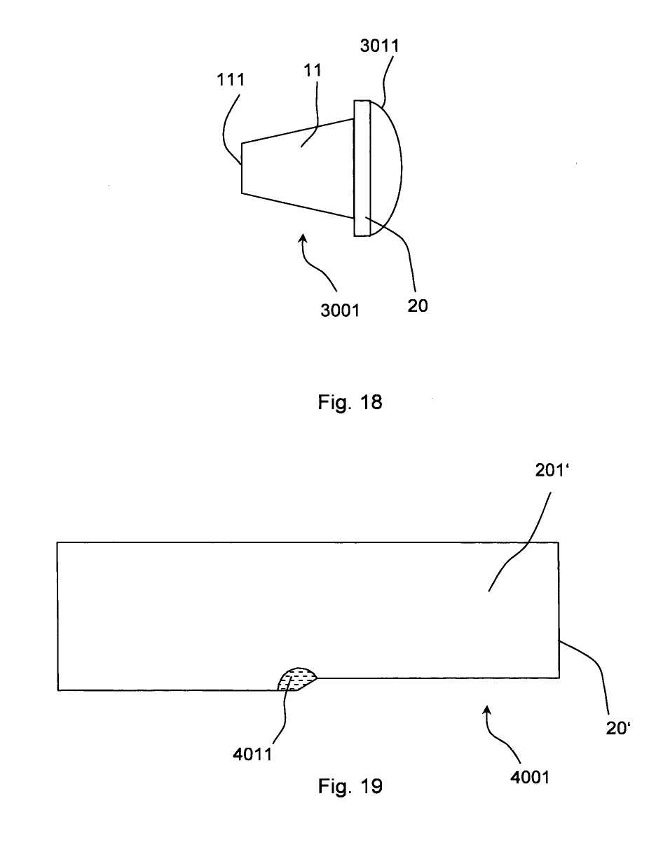

The convex coatings 2011, 2012, 2013, 2014, 2015 may be used, for example, for implementing optical structures or primary optical elements as they are disclosed (similarly), for example, in DE 10 2013 200 442 B3. To this end, the coatings obtained by 3D printing processes may be designed to be larger, as is represented, for example, by the primary optical array 3001 in FIG. 18 by using the optical structure (or coating) 3011 instead of the coating 2011. For example, the optical structure 3011 may be used for implementing the optical structure designated with reference numeral 12.a in DE 10 2013 200 442 B3 (incorporated by reference in its entirety), or a similar or comparable optical structure, or for implementing the optical structure designated with reference numerals 21, 22, 23, 24 in DE 10 2010 029 176 A1 (incorporated by reference in its entirety), or a similar or comparable optical structure.

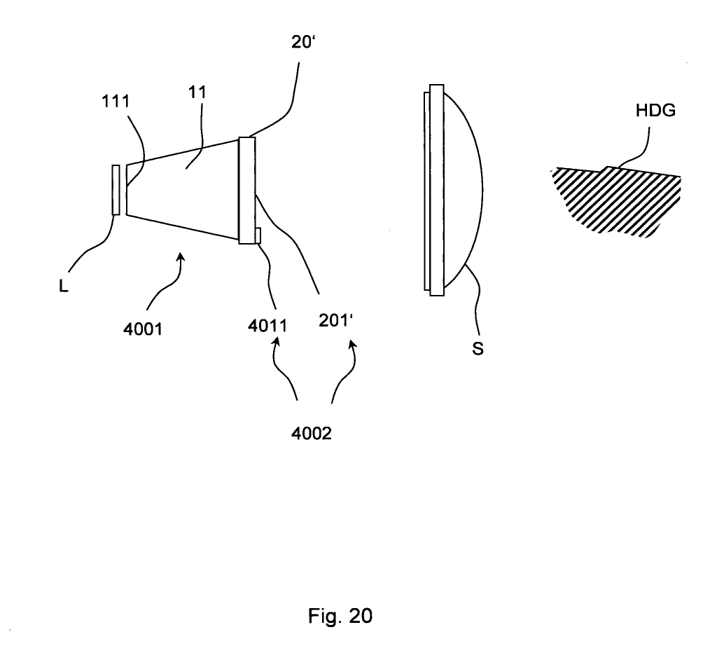

A preferred exemplified embodiment of a coated primary optical array 4001 is shown, for example, in FIG. 19. Here, the coated primary optical array 4001 comprises a basic part 20′ differing from the basic part 20 for example by a bend or a double bend at its outer contour. This double bend serves to create a double bend in the bright-dark boundary, as is shown, for example, in FIG. 20. The coated primary optical array 4001 or its basic part 20′ has a polished surface 201′ corresponding to the polished surface 201 and being arranged on the side of the basic part 20 facing away from the primary optical elements. The polished surface 201′ has, in the region of the double bend, a coating 4011 having a roughness lower than the roughness of the polished surface 201′. The roughness Ra of the coating 4011 is, for example, less than 0.05. The coating 4011 may be applied, for example, by a stamp printing process or a 3D printing process. The coating 4011 may be an adhesive, a varnish, or a 3D printing medium, such as Ormocer. As an alternative to the coating 4011, a corresponding laser polishing may be provided in this region.

FIG. 20 shows a vehicle headlight or motor vehicle headlight in a general representation. The vehicle headlight comprises a light source arrangement L, for example comprising LEDs, for irradiating light into the light entry face 111 or its light entry faces of its primary optical elements, such as the primary optical element 11, corresponding to the light entry faces 112, 113, 114, and 115. Moreover, the vehicle headlight comprises a secondary lens S for imaging the light exit face 4002 of the coated primary optical array 4001 as a bright-dark boundary HDG.

The elements in the Figures are drawn taking into consideration simplicity and clarity, and are not necessarily drawn to scale. For example, the dimensions of some elements are represented in a (sometimes clearly) exaggerated manner with respect to other elements to enhance the understanding of the exemplified embodiments of the present invention. Equal reference numerals relate to or designate equal or equivalent elements.

The invention provides for an improved primary optical array. Here, it is in particular desirable to provide an primary optical array for a vehicle headlight with particularly good photometric values comprising a first primary optical element and at least one second primary optical element. Here, it e.g. provided for reducing or suppressing the so-called picket effect. The so-called picket effect is described, for example, in PCT/EP2014/001425. It is moreover provided for making such an primary optical array of inorganic glass in series or on an industrial scale.

1-11. (canceled)

12. A vehicle headlight comprising:
monolithic primary optical array of inorganic glass, the primary optical array comprising:
a first primary optical element with a first light entry face,
at least a second primary optical element with a second light entry face, and
a basic part connecting the first primary optical element to the second primary optical element, wherein the distance between the first primary optical element and the second primary optical element amounts to no more than 0.1 mm, the base part providing for an light exit face;
a light source arrangement configured for irradiating light into the first light entry face and the second light entry face; and
a secondary lens for imaging the light exit face an a bright-dark boundary.

13. The vehicle headlight of claim 12, the primary optical array further comprising:
at least a third primary optical element with a third light entry face, the basic part connecting the third primary optical element to the second primary optical element, wherein the distance between the third primary optical element and the second primary optical element amounts to no more than 0.1 mm, the light source arrangement being configured for irradiating light into the third light entry face.

14. The vehicle headlight of claim 13, the primary optical array further comprising:
at least a fourth primary optical element with a fourth light entry face, the basic part connecting the third primary optical element to the fourth primary optical element, wherein the distance between the third primary optical element and the fourth primary optical element amounts to no more than 0.1 mm, the light source arrangement being configured for irradiating light into the fourth light entry face.

15. The vehicle headlight of claim 14 wherein the first primary optical element comprises a surface configured for total internal reflection between the first light entry face and the basic part, wherein the second primary optical element comprises a surface configured for total internal reflection between the second light entry face and the basic part, wherein the third primary optical element comprises a surface configured for total internal reflection between the third light entry face and the basic part, wherein the fourth primary optical element comprises a surface configured for total internal reflection between the fourth light entry face and the basic part.

16. The vehicle headlight of claim 15 wherein the light exit surface is a polished surface.

17. The vehicle headlight of claim 16 wherein the light exit surface is partially coated.

18. The vehicle headlight of claim 16 wherein the polished surface is in parts provided with a coating having a roughness that is lower than the roughness of the polished surface.

19. A vehicle headlight comprising:
monolithic primary optical array of inorganic glass, the primary optical array comprising:
a first primary optical element with a first light entry face,
at least a second primary optical element with a second light entry face, and
a basic part connecting the first primary optical element to the second primary optical element, wherein the first primary optical element transitions into the basic part such that light irradiated into the first light entry face exits from the basic part, wherein the second primary optical element transitions into the basic part such that light irradiated into the second light entry face exits from the basic part, wherein the distance between the first primary optical element and the second primary optical element amounts to no more than 20% of the shortest light path between the first light entry face and a light exit face provided for by the base part;
a light source arrangement configured for irradiating light into the first light entry face and the second light entry face; and
a secondary lens for imaging the light exit face an a bright-dark boundary.

20. The vehicle headlight of claim 19, the primary optical further comprising:
third primary optical element with a third light entry face, wherein the distance between the second primary optical element and the third primary optical element amounts to no more than 20% of the shortest light path between the second light entry face and a light exit face provided for by the base part, the light source arrangement being configured for irradiating light into the third light entry face, and
at least a fourth primary optical element with a fourth light entry face, wherein the distance between the third primary optical element and the forth primary optical element amounts to no more than 20% of the shortest light path between the third light entry face and a light exit face provided for by the base part, the light source arrangement being configured for irradiating light into the fourth light entry face.

21. The vehicle headlight of claim 20 wherein the first primary optical element comprises a surface configured for total internal reflection between the first light entry face and the basic part, wherein the second primary optical element comprises a surface configured for total internal reflection between the second light entry face and the basic part, wherein the third primary optical element comprises a surface configured for total internal reflection between the third light entry face and the basic part, wherein the fourth primary optical element comprises a surface configured for total internal reflection between the fourth light entry face and the basic part.

22. The vehicle headlight of claim 21 wherein the light exit surface is a polished surface.

23. The vehicle headlight of claim 22 wherein the light exit surface is partially coated.

24. The vehicle headlight of claim 22 wherein the polished surface is in parts provided with a coating having a roughness that is lower than the roughness of the polished surface.

25. A vehicle headlight comprising:
monolithic primary optical array of inorganic glass, the primary optical array comprising:
a first primary optical element with a first light entry face,
a second primary optical element with a second light entry face,
at least a third primary optical element with a third light entry face, and
a basic part connecting the first primary optical element to the second primary optical element, the first primary optical element to the third primary optical element, the third primary optical element to the second primary optical element, wherein the distance between the first primary optical element and the second primary optical element amounts to no more than 0.25 mm, wherein the distance between the third primary optical element and the second primary optical element amounts to no more than 0.25 mm, wherein the first primary optical element transitions into the basic part such that light irradiated into the first light entry face exits from the basic part,
wherein the second primary optical element transitions into the basic part such that light irradiated into the second light entry face exits from the basic part, wherein the third primary optical element transitions into the basic part such that light irradiated into the third light entry face exits from the basic part;
a light source arrangement configured for irradiating light into the first light entry face, the second light entry face and the third light entry face; and
a secondary lens for imaging light exiting the base part as a bright-dark boundary.

26. The vehicle headlight of claim 25, the primary optical further comprising: at least a fourth primary optical element with a fourth light entry face, wherein the distance between the third primary optical element and the forth primary optical element amounts to no more than 0.25 mm, wherein the fourth primary optical element transitions into the basic part such that light irradiated into the fourth light entry face exits from the basic part, the light source arrangement being configured for irradiating light into the fourth light entry face.

27. The vehicle headlight of claim 26 wherein the first primary optical element comprises a surface configured for total internal reflection between the first light entry face and the basic part, wherein the second primary optical element comprises a surface configured for total internal reflection between the second light entry face and the basic part, wherein the third primary optical element comprises a surface configured for total internal reflection between the third light entry face and the basic part, wherein the fourth primary optical element comprises a surface configured for total internal reflection between the fourth light entry face and the basic part.

28. The vehicle headlight of claim 27 wherein the light exit surface is a polished surface.

29. The vehicle headlight of claim 28 wherein the light exit surface is partially coated.

30. The vehicle headlight of claim 28 wherein the polished surface is in parts provided with a coating having a roughness that is lower than the roughness of the polished surface.
